(19) United States
(12) Patent Application Publication
(10) Pub. No.: US 2018/0094702 A1
(43) Pub. Date: Apr. 5, 2018

(54) PLANETARY GEAR TRAIN OF AN AUTOMATIC TRANSMISSION FOR VEHICLES

(71) Applicant: HYUNDAI MOTOR COMPANY, Seoul (KR)

(72) Inventors: Jin Ho Kim, Suwon-si (KR); Jinseok Kim, Seoul (KR); Jae Chang Kook, Hwaseong-si (KR); Dong Hwan Hwang, Seoul (KR); Seong Wook Hwang, Gunpo-si (KR); Woo Jin Chang, Suwon-si (KR); Tae Whan Kim, Yongin-si (KR); Seongwook Ji, Gunpo-si (KR); Chon Ok Kim, Yongin-si (KR); Wonmin Cho, Hwaseong-si (KR); Hyun Sik Kwon, Seoul (KR); Jong Sool Park, Hwaseong-si (KR); Kyeong Hun Lee, Seoul (KR); Jong Soo Kim, Seoul (KR)

(73) Assignee: HYUNDAI MOTOR COMPANY, Seoul (KR)

(21) Appl. No.: 15/376,041

(22) Filed: Dec. 12, 2016

(30) Foreign Application Priority Data
Oct. 4, 2016 (KR) 10-2016-0127466

(51) Int. Cl. F16H 3/66

(52) U.S. Cl. CPC F16H 3/66; F16H 2200/2048; F16H 2200/2012; F16H 2200/0069

(57) ABSTRACT

A planetary gear train of an automatic transmission for a vehicle includes: an input shaft for receiving an engine torque; an output shaft for outputting a changed torque; and first, second, third, and fourth planetary gear sets each including three rotational elements. The gear train also includes eight shafts for selectively connecting the planetary gear sets, the input and output shafts, and a transmission housing in various configurations to achieve at least ten forward speeds and at least one reverse speed.

### CROSS-REFERENCE TO RELATED APPLICATION

This application claims priority to and the benefit of Korean Patent Application No. 10-2016-0127466 filed in the Korean Intellectual Property Office on Oct. 4, 2016, the entire contents of which are incorporated herein by reference.

### BACKGROUND

### (a) Field of the Disclosure

The present disclosure relates to automatic transmissions for vehicles. More particularly, the present disclosure relates to a planetary gear train of an automatic transmission for a vehicle.

### (b) Description of the Related Art

Research into realizing more shift-stages of automatic transmissions has been undertaken to enhance fuel consumption and improve drivability. Increasing oil prices have triggered fierce competition to enhance vehicle fuel consumption.

Therefore, research in the field of engines has been undertaken to achieve weight reduction and to enhance fuel consumption by so-called downsizing. Research in the field of automatic transmissions has also been performed to simultaneously provide better drivability and fuel consumption by achieving more shift stages.

In order to achieve more shift stages for an automatic transmission, the number of parts is typically increased, which may deteriorate installability, production cost, weight and/or power flow efficiency.

Recently, eight-speed automatic transmissions have been introduced. Planetary gear trains for automatic transmissions enabling more shift stages are under investigation.

Conventional automatic transmissions of eight or more shift-stages typically include three to four planetary gear sets and five to seven control elements (frictional elements). Thus, the transmission may easily become lengthy, thereby deteriorating installability.

In this regard, disposing planetary gear sets in parallel or employing dog clutches instead of wet-type control elements have been attempted. However, such arrangements may not be widely applicable, and using dog clutches may easily deteriorate shift-feel.

Considering that gear ratio spans of recently developed eight-speed automatic transmissions are typically between 6.5 and 7.5, fuel consumption enhancement is not very large. In the case of a gear ratio span of an eight-speed automatic transmission having a level above 9.0, it is difficult to maintain step ratios between adjacent shift stages to be linear. This may lead to driving efficiency of an engine and drivability of a vehicle being deteriorated.

Thus, research studies are underway for developing a high efficiency automatic transmission having nine or more speeds.

The above information disclosed in this Background section is only to enhance understanding of the background of the disclosure. Therefore, the background may contain information that is not prior art that is already known in this country to a person of ordinary skill in the art.

### SUMMARY

The present disclosure is directed to a planetary gear train of an automatic transmission for a vehicle. The disclosed planetary gear train realizes, by minimal complexity, at least ten forward speeds and at least one reverse speed. The disclosed planetary gear train also increases a gear ratio span to improve power delivery performance and fuel consumption, and achieves linearity of shift stage step ratios.

A planetary gear train of an automatic transmission for a vehicle according to an embodiment of the present disclosure includes: an input shaft for receiving an engine torque; an output shaft for outputting changed torque; a first planetary gear set including first, second, and, third rotational elements; a second planetary gear set including fourth, fifth, and sixth rotational elements; a third planetary gear set including seventh, eighth, and ninth rotational elements; a fourth planetary gear set including tenth, eleventh and, twelfth rotational elements; a first shaft connecting the first rotational element and the fifth rotational element, and connected to the input shaft; a second shaft connected to the second rotational element; a third shaft connecting the third rotational element and the eighth rotational element, and selectively connected to a transmission housing; a fourth shaft connected to the fourth rotational element, and selectively connected to the transmission housing; a fifth shaft connecting the sixth rotational element and the tenth rotational element; a sixth shaft connecting the ninth rotational element and the twelfth rotational element, and selectively connected to the transmission housing; and a seventh shaft connected to the eleventh rotational element and connected to the output shaft.

The second shaft may be selectively connected to the fifth shaft and the sixth shaft. The disclosed planetary gear train may further include an eighth shaft connected to the seventh rotational element and selectively connected to the first shaft and the fourth shaft, respectively.

The first, second, and third rotational elements of the first planetary gear set are respectively a first sun gear, a first planet carrier, and a first ring gear of the first planetary gear set. The fourth, fifth, and sixth rotational elements of the second planetary gear set are respectively a second sun gear, a second planet carrier, and a second ring gear of the second planetary gear set. The seventh, eighth, and ninth rotational elements of the third planetary gear set are respectively a third sun gear, a third planet carrier, and a third ring gear of the third planetary gear set. The tenth, eleventh, and twelfth rotational elements of the fourth planetary gear set are respectively a fourth sun gear, a fourth planet carrier, and a fourth ring gear of the fourth planetary gear set.

In one embodiment, the first, second, third, and fourth planetary gear sets may be arranged in a sequence of the third, second, first, and fourth planetary gear sets from an engine side.

The planetary gear train according to an embodiment of the present disclosure may further include: a first clutch selectively connecting the first shaft and the eighth shaft; a second clutch selectively connecting the second shaft and the fifth shaft; a third clutch selectively connecting the second shaft and the sixth shaft; a fourth clutch selectively connecting the fourth shaft and the eighth shaft; a first brake selectively connecting the third shaft and the transmission housing; a second brake selectively connecting the sixth shaft and the transmission housing; and a third brake selectively connecting the fourth shaft and the transmission housing.

The planetary gear train according to an embodiment of the present disclosure may realize at least ten forward speeds and at least one reverse speed by operating the four planetary gear sets as simple planetary gear sets and by controlling seven control elements.

In addition, a planetary gear train according to an embodiment of the present disclosure may realize a gear ratio span of more than 10.0, thereby maximizing engine driving efficiency.

In addition, the linearity of step ratios of shift stages is secured while multi-staging the shift stage with high efficiency. This improves drivability such as acceleration before and after a shift, creates a rhythmic engine speed, and the like.

Further, effects that may be obtained or expected from embodiments of the present disclosure are directly or suggestively described in the following detailed description. In other words, various effects expected from embodiments of the present disclosure are described in the following detailed description.

### BRIEF DESCRIPTION OF THE DRAWINGS

FIG. 1 is a schematic diagram of a planetary gear train according to an embodiment of the present disclosure.

FIG. 2 is an operational chart for respective control elements at respective shift stages in a planetary gear train according to an embodiment of the present disclosure.

### DETAILED DESCRIPTION OF THE EMBODIMENTS

It is desired to develop a planetary gear train having advantages of realizing, by minimal complexity, at least ten forward speeds and at least one reverse speed. In this aspect, the present disclosure relates to a planetary gear train of an automatic transmission for a vehicle. The disclosed planetary gear train may improve power delivery performance and fuel consumption by using a smaller number of parts and by increasing a gear ratio span. The disclosed planetary gear train may also achieve linearity of shift stage step ratios.

The present disclosure is described more fully hereinafter with reference to the accompanying drawings, in which embodiments of the disclosure are shown. As those skilled in the art would realize, the described embodiments may be modified in various ways, all without departing from the spirit or scope of the present disclosure. In the drawings, the following symbols are used to identify various elements of the disclosed embodiments, wherein:
i. B1, B2, B3 represent first, second, and third brakes;
ii. C1, C2, C3, C4 represent first, second, third, and fourth clutches;
iii. PG1, PG2, PG3, PG4 represent first, second, third, and fourth planetary gear sets;
iv. S1, S2, S3, S4 represent first, second, third, and fourth sun gears;
v. PC1, PC2, PC3, PC4 represent first, second, third, and fourth planet carriers;
vi. R1, R2, R3, R4 represent first, second, third, and fourth ring gears;
vii. P1, P2, P3, P4 represent first, second, third, and fourth pinion gears;
viii. IS represents an input shaft;
ix. OS represents an output shaft; and
x. TM1, TM2, TM3, TM4, TM5, TM6, TM7, TM8 represent first, second, third, fourth, fifth, sixth, seventh, and eighth shafts.

The drawings and description are to be regarded as illustrative in nature and not restrictive. Like reference numerals designate like elements throughout the specification.

In the following description, using names or terms to identify components such as first, second, third and the like is to differentiate the names because the names of the components are otherwise the same as each other. Such a naming convention is not intended to denote or set an order thereof and the disclosure is not intended to be so limited.

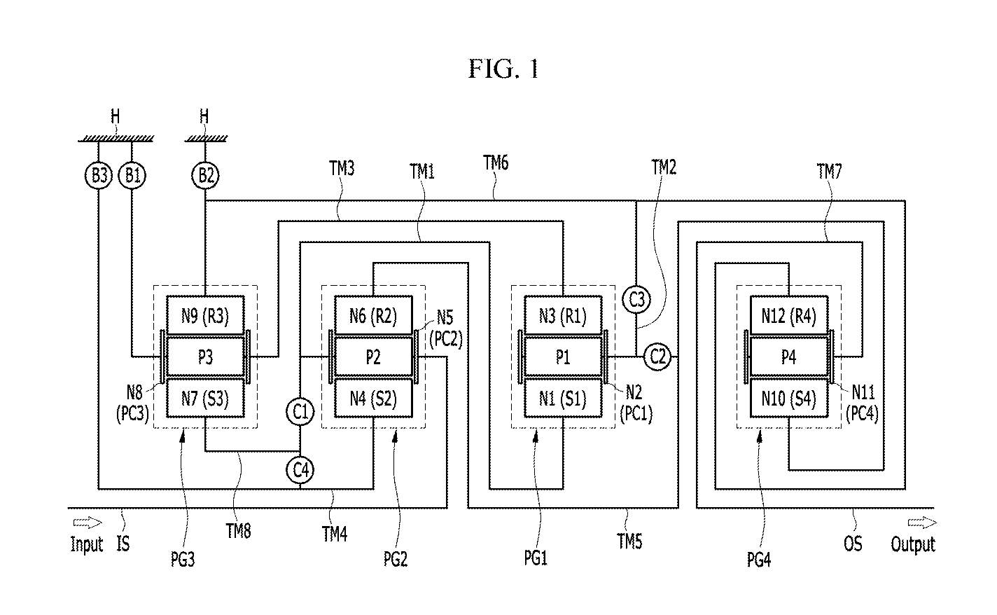

FIG. 1 is a schematic diagram of a planetary gear train according to one embodiment of the present disclosure.

Referring to FIG. 1, a planetary gear train according to one embodiment of the present disclosure includes first, second, third, and fourth planetary gear sets PG1, PG2, PG3, and PG4 arranged on a same axis. In one embodiment, the planetary gear train also includes an input shaft IS, an output shaft OS, eight shafts TM1-TM8 interconnecting rotational elements of the first, second, third, and fourth planetary gear sets PG1, PG2, PG3, and PG4, four clutches C1-C4 that are control elements and two brakes B1 and B2 that are also control elements, and a transmission housing H.

Torque input from the input shaft IS is shifted by cooperative operation of the first, second, third, and fourth planetary gear sets PG1, PG2, PG3, and PG4. The changed torque is then output through the output shaft OS.

In this embodiment, the planetary gear sets are arranged in the order of third, second, first, and fourth planetary gear sets PG3, PG2, PG1, and PG4 from an engine side.

The input shaft IS is an input member. Torque from a crankshaft of an engine is input into the input shaft IS, after being torque-converted through a torque converter.

The output shaft OS is an output member. The output shaft OS is arranged on the same axis as the input shaft IS and delivers a shifted driving torque to a drive shaft through a differential apparatus (not shown).

In this embodiment, the first planetary gear set PG1 is a single pinion planetary gear set. The first planetary gear set PG1 includes a first planet carrier PC1 that supports a first pinion gear P1 that is externally engaged with the first sun gear S1, and a first ring gear R1 that is internally engaged with the first pinion gear P1. The first sun gear S1 acts as a first rotational element N1, the first planet carrier PC1 acts as a second rotational element N2, and the first ring gear R1 acts as a third rotational element N3.

In this embodiment, the second planetary gear set PG2 is a single pinion planetary gear set. The second planetary gear set PG2 includes a second planet carrier PC2 that supports a second pinion gear P2 that is externally engaged with the second sun gear S2, and a second ring gear R2 that is internally engaged with the second pinion gear P2. The second sun gear S2 acts as a fourth rotational element N4, the second planet carrier PC2 acts as a fifth rotational element N5, and the second ring gear R2 acts as a sixth rotational element N6.

In this embodiment, the third planetary gear set PG3 is a single pinion planetary gear set. The third planetary gear set PG3 includes a third planet carrier PC3 that supports a third pinion gear P3 that is externally engaged with the third sun gear S3, and a third ring gear R3 that is internally engaged with the third pinion gear P3. The third sun gear S3 acts as a seventh rotational element N7, the third planet carrier PC3 acts as an eighth rotational element N8, and the third ring gear R3 acts as a ninth rotational element N9.

In this embodiment, the fourth planetary gear set PG4 is a single pinion planetary gear set. The fourth planetary gear set PG4 includes a fourth planet carrier PC4 that supports a fourth pinion gear P4 that is externally engaged with the fourth sun gear S4, and a fourth ring gear R4 that is internally engaged with the fourth pinion gear P4. The fourth sun gear S4 acts as a tenth rotational element N10, the fourth planet carrier PC4 acts as an eleventh rotational element N11, and the fourth ring gear R4 acts as a twelfth rotational element N12.

In this embodiment of the first, second, third, and fourth planetary gear sets PG1, PG2, PG3, and PG4, the first rotational element N1 is directly connected with the fifth rotational element N5. The third rotational element N3 is directly connected with the eighth rotational element N8. The sixth rotational element N6 is directly connected with the tenth rotational element N10. The ninth rotational element N9 is directly connected with the twelfth rotational element N12. Each of these connections may be made using at least one of eight shafts TM1-TM8.

The eight shafts TM1-TM8 are hereinafter described in detail.

Each of the eight shafts TM1-TM8 may be a rotational member that directly connects the input and output shafts and the rotational elements of the planetary gear sets PG1, PG2, PG3, and PG4. The eight shafts TM1-TM8 may also be fixed, members fixed to the transmission housing H.

In this embodiment, the first shaft TM1 may connect the first rotational element N1 (the first sun gear S1) and the fifth rotational element N5 (the second planet carrier PC2). The first shaft TM1 is also directly connected to the input shaft IS, thereby always acting as an input element.

In this embodiment, the second shaft TM2 may be connected to the second rotational element N2 (the first planet carrier PC1).

In this embodiment, the third shaft TM3 may connect the third rotational element N3 (the first ring gear R1) and the eighth rotation element N8 (the third planet carrier PC3). The third shaft TM3 may also be selectively connected to the transmission housing H, thereby acting as a selective fixed element.

In this embodiment, the fourth shaft TM4 may be connected to the fourth rotational element N4 (the second sun gear S2). The fourth shaft TM4 may also be selectively connected to the transmission housing H, thereby acting as a selective fixed element.

In this embodiment, the fifth shaft TM5 may connect the sixth rotational element N6 (the second ring gear R2) and the tenth rotational element N10 (the fourth sun gear S4). The fifth shaft TM5 may also be selectively connected to the second shaft TM2.

In this embodiment, the sixth shaft may connect the ninth rotational element N9 (the third ring gear R3) and the twelfth rotational element N12 (the fourth ring gear R4). The sixth shaft TM6 is also selectively connected to the second shaft TM2. The sixth shaft TM6 may also be selectively connected to the transmission housing H, thereby acting as a selective fixed element.

In this embodiment, the seventh shaft TM7 may be connected to the eleventh rotational element N11 (the fourth planet carrier PC4). The seventh shaft TM7 is also directly connected to the output OS, thereby always acting an output element.

In this embodiment, the eighth shaft TM8 may be connected to the seventh rotational element N7 (the third sun gear S3). The eighth shaft TM8 is also selectively connected to the first shaft TM1 and the fourth shaft TM4, respectively.

In this embodiment, the eight shafts TM1-TM8, the input shaft IS, and the output shaft OS may be selectively connected with one another by control elements of four clutches C1, C2, C3, and C4.

In addition, in this embodiment, the eight shafts TM1-TM8 may be selectively connected with the transmission housing H by control elements of three brakes B1, B2, and B3.

The four clutches C1-C4 and the three brakes B1-B3 are arranged as follows.

In this embodiment, the first clutch C1 is arranged between the first shaft TM1 and the eighth shaft TM8. The first clutch C1 selectively connects the first shaft TM1 and the eighth shaft TM8, thereby delivering power therebetween.

In this embodiment, the second clutch C2 is arranged between the second shaft TM2 and the fifth shaft TM5. The second clutch C2 selectively connects the second shaft TM2 and the fifth shaft TM5, thereby controlling power delivery therebetween.

In this embodiment, the third clutch C3 is arranged between the second shaft TM2 and the sixth shaft TM6. The third clutch C3 selectively connects the second shaft TM2 and the sixth shaft TM6, thereby controlling power delivery therebetween.

In this embodiment, the fourth clutch C4 is arranged between the fourth shaft TM4 and the eighth shaft TM8. The fourth clutch C4 selectively connects the fourth shaft TM4 and the eighth shaft TM8, thereby controlling power delivery therebetween.

In this embodiment, the first brake B1 is arranged between the third shaft TM3 and the transmission housing H. The first brake B1 selectively connects the third shaft TM3 to the transmission housing H.

In this embodiment, the second brake B2 is arranged between the sixth shaft TM6 and the transmission housing H. The second brake B2 selectively connects the sixth shaft TM6 to the transmission housing H.

In this embodiment, the third brake B3 is arranged between the fourth shaft TM4 and the transmission housing H. The third brake B3 selectively connects the fourth shaft TM4 to the transmission housing H.

The respective control elements of the first, second, third, and fourth clutches C1, C2, C3, and C4 and the first, second, and third brakes B1, B2, and B3 may be multi-plate hydraulic pressure friction devices that are frictionally engaged by hydraulic pressure.

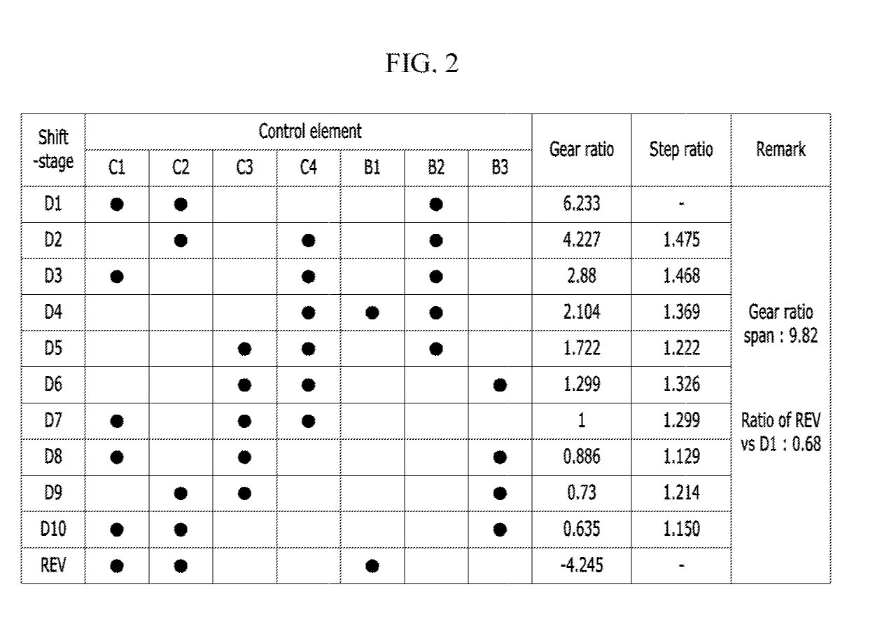

FIG. 2 is an operational chart for the respective control elements at respective shift stages in a planetary gear train according to an embodiment of the present disclosure.

Referring to FIG. 2, a planetary gear train according to an embodiment of the present disclosure realizes ten forward speeds and one reverse speed by operating three control elements among the first, second, third, and fourth clutches C1, C2, C3, and C4 and the first, second, and third brakes B1, B2, and B3 at respective shift-stages.

In this embodiment, in the forward first speed shift-stage D1, the first and second clutches C1 and C2 and the second brake B2 are simultaneously operated.

As a result, the first shaft TM1 is connected with the eighth shaft TM8 by operation of the first clutch C1 and the second shaft TM2 is connected with the fifth shaft TM5 by operation of the second clutch C2. In this state, the torque of the input shaft IS is input to the first shaft TM1.

In addition, the sixth shaft TM6 acts as a fixed element by operation of the second brake B2, thereby realizing the forward first speed by cooperative operation of respective shafts and outputting a shifted torque to the output shaft OS connected with the seventh shaft TM7.

In this embodiment, in the forward second speed shift-stage D2, the second and fourth clutches C2 and C4 and the second brake B2 are simultaneously operated.

As a result, the second shaft TM2 is connected with the fifth shaft TM5 by operation of the second clutch C2 and the fourth shaft TM4 is connected with the eighth shaft TM8 by operation of the fourth clutch C4. In this state, the torque of the input shaft IS is input to the first shaft TM1.

In addition, the sixth shaft TM6 acts as the fixed element by operation of the second brake B2, thereby realizing the forward second speed by cooperative operation of respective shafts and outputting a shifted torque to the output shaft OS connected with the seventh shaft TM7.

In this embodiment, in the forward third speed shift-stage D3, the first and fourth clutches C1 and C4 and the second brake B2 are simultaneously operated.

As a result, the first shaft TM1 is connected with the eighth shaft TM8 by operation of the first clutch C1 and the fourth shaft TM4 is connected with the eighth shaft TM8 by operation of the fourth clutch C4. In this state, the torque of the input shaft IS is input to the first shaft TM1.

In addition, the sixth shaft TM6 acts as the fixed element by operation of the second brake B2, thereby realizing the forward third speed by cooperative operation of respective shafts and outputting a shifted torque to the output shaft OS connected with the seventh shaft TM7.

In this embodiment, in the forward fourth speed shift-stage D4, the fourth clutch C4 and the first and second brakes B1 and B2 are simultaneously operated.

As a result, the fourth shaft TM4 is connected with the eighth shaft TM8 by operation of the fourth clutch C4 and the torque of the input shaft IS is input to the first shaft TM1.

In addition, the third and sixth shafts TM3 and TM6 act as the fixed elements by operation of the first and second brakes B1 and B2, thereby realizing the forward fourth speed by cooperative operation of respective shafts and outputting a shifted torque to the output shaft OS connected with the seventh shaft TM7.

In this embodiment, in the forward fifth speed shift-stage D5, the third and fourth clutches C3 and C4 and the second brake B2 are simultaneously operated.

As a result, the second shaft TM2 is connected with the sixth shaft TM6 by operation of the third clutch C3 and the fourth shaft TM4 is connected with the eighth shaft TM8 by the operation of the fourth clutch C4. In this state, the torque of the input shaft IS is input to the first shaft TM1.

In addition, the sixth shaft TM6 acts as a fixed element by operation of the second brake B2, thereby realizing the forward fifth speed by cooperative operation of respective shafts and outputting a shifted torque to the output shaft OS connected with the seventh shaft TM7.

In this embodiment, in the forward sixth speed shift-stage D6, the third and fourth clutches C3 and C4 and the third brake B3 are simultaneously operated.

As a result, the second shaft TM2 is connected with the sixth shaft TM6 by operation of the third clutch C3 and the fourth shaft TM4 is connected with the eighth shaft TM8 by the operation of the fourth clutch C4. In this state, the torque of the input shaft IS is input to the first shaft TM1.

In addition, the fourth shaft TM4 acts as a fixed element by operation of the third brake B3, thereby realizing the forward sixth speed by cooperative operation of respective shafts and outputting a shifted torque to the output shaft OS connected with the seventh shaft TM7.

In this embodiment, in the forward seventh speed shift-stage D7, the first, third and fourth clutches C1, C3 and C4 are simultaneously operated.

As a result, the first shaft TM1 is connected, with the eighth shaft TM8 by operation of the first clutch C1, the second shaft TM2 is connected with the sixth shaft TM6 by operation of the third clutch C3, and the fourth shaft TM4 is connected with the eighth shaft TM8 by the operation of the fourth clutch C4. In this state, the torque of the input shaft IS is input to the first shaft TM1.

In this arrangement, each of the planetary gear sets PG1, PG2, PG3, and PG4 integrally rotate and a torque output through the output shaft OS is the same as the torque input through the input shaft IS. In this arrangement, the forward seventh speed is formed and the inputted torque is outputted to the output shaft OS connected with the seventh shaft TM7.

In this embodiment, in the forward eighth speed shift-stage D8, the first and third clutches C1 and C3 and the third brake B3 are simultaneously operated.

As a result, the first shaft TM1 is connected with the eighth shaft TM8 by operation of the first clutch C1 and the second shaft TM2 is connected with the sixth shaft TM6 by the operation of the third clutch C3. In this state, the torque of the input shaft IS is input to the first shaft TM1.

In addition, the fourth shaft TM4 acts as a fixed element by operation of the third brake B3, thereby realizing the forward eighth speed by cooperative operation of respective shafts and outputting a shifted torque to the output shaft OS connected with the seventh shaft TM7.

In this embodiment, in the forward ninth speed shift-stage D9, the second and third clutches C2 and C3 and the third brake B3 are simultaneously operated.

As a result, the second shaft TM2 is connected with the fifth shaft TM5 by operation of the second clutch C2 and the second shaft TM2 is connected with the sixth shaft TM6 by operation of the third clutch C3. In this state, the torque of the input shaft IS is input to the first shaft TM1.

In addition, the fourth shaft TM4 acts as a fixed element by operation of the third brake B3, thereby realizing the forward ninth speed by cooperative operation of respective shafts and outputting a shifted torque to the output shaft OS connected with the seventh shaft TM7.

In this embodiment, in the forward tenth speed shift-stage D10, the first and second clutches C1 and C2 and the third brake B3 are simultaneously operated.

As a result, the first shaft TM1 is connected with the eighth shaft TM8 by operation of the first clutch C1 and the second shaft TM2 is connected with the fifth shaft TM5 by operation of the second clutch C2. In this state, the torque of the input shaft IS is input to the first shaft TM1.

In addition, the fourth shaft TM4 acts as a fixed element by operation of the third brake B3, thereby realizing the forward tenth speed by cooperative operation of respective shafts and outputting a shifted torque to the output shaft OS connected with the seventh shaft TM7.

In this embodiment, in the reverse speed REV, the first and second clutches C1 and C2 and the first brake B1 are simultaneously operated.

As a result, the first shaft TM1 is connected with the eighth shaft TM8 by operation of the first clutch C1 and the second shaft TM2 is connected with the fifth shaft TM5 by operation of the second clutch C2. In this state, the torque of the input shaft IS is input to the first shaft TM1.

In addition, the third shaft TM3 acts as the fixed element by operation of the first brake B1, thereby realizing the reverse speed by cooperative operation of respective shafts and outputting a reverse torque to the output shaft OS connected with the seventh shaft TM7.

As described above, a planetary gear train according to an embodiment of the present disclosure may realize at least ten forward speeds and at least one reverse speed by operating four planetary gear sets PG1, PG2, PG3, and PG4 by controlling the four clutches C1, C2, C3, and C4 and the three brakes B1 B2, and B3.

In addition, a planetary gear train according to an embodiment of the present disclosure may realize a gear ratio span of more than 9.0, thereby maximizing engine driving efficiency.

In addition, the linearity of step ratios of shift stages is secured while multi-staging the shift stage with high efficiency. This improves drivability such as acceleration before and after a shift, creates a rhythmic engine speed, and the like.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A planetary gear train of an automatic transmission for a vehicle, the planetary gear train comprising:
an input shaft for receiving an engine torque;
an output shaft for outputting a changed torque;
a first planetary gear set including a first, a second, and a third rotational element;
a second planetary gear set including a fourth, a fifth, and a sixth rotational element;
a third planetary gear set including a seventh, an eighth, and a ninth rotational element;
a fourth planetary gear set including a tenth, an eleventh and a twelfth rotational element;
a first shaft connecting the first rotational element and the fifth rotational element and connected to the input shaft;
a second shaft connected to the second rotational element;
a third shaft connecting the third rotational element and the eighth rotational element and selectively connected to a transmission housing;
a fourth shaft connected to the fourth rotational element and selectively connected to the transmission housing;
a fifth shaft connecting the sixth rotational element and the tenth rotational element;
a sixth shaft connecting the ninth rotational element and the twelfth rotational element and selectively connected to the transmission housing; and
a seventh shaft connected to the eleventh rotational element and connected to the output shaft.

2. The planetary gear train of claim 1, wherein the second shaft is selectively connected to the fifth shaft and the sixth shaft and further comprising:
an eighth shaft connected to the seventh rotational element and selectively connected to the first shaft and the fourth shaft, respectively.

3. The planetary gear train of claim 1, wherein:
the first, second, and third rotational elements of the first planetary gear set are respectively a first sun gear, a first planet carrier, and a first ring gear of the first planetary gear set;
the fourth, fifth, and sixth rotational elements of the second planetary gear set are respectively a second sun gear, a second planet carrier, and a second ring gear of the second planetary gear set;
the seventh, eighth, and ninth rotational elements of the third planetary gear set are respectively a third sun gear, a third planet carrier, and a third ring gear of the third planetary gear set; and
the tenth, eleventh, and twelfth rotational elements of the fourth planetary gear set are respectively a fourth sun gear, a fourth planet carrier, and a fourth ring gear of the fourth planetary gear set.

4. The planetary gear train of claim 1, wherein:
the first, second, third, and fourth planetary gear sets are arranged in a sequence of the third, second, first, and fourth planetary gear sets from an engine side.

5. The planetary gear train of claim 2, further comprising:
a first clutch selectively connecting the first shaft and the eighth shaft;
a second clutch selectively connecting the second shaft and the fifth shaft;
a third clutch selectively connecting the second shaft and the sixth shaft;
a fourth clutch selectively connecting the fourth shaft and the eighth shaft;
a first brake selectively connecting the third shaft and the transmission housing;
a second brake selectively connecting the sixth shaft and the transmission housing; and
a third brake selectively connecting the fourth shaft and the transmission housing.

6. A planetary gear train of an automatic transmission for a vehicle, the planetary gear train comprising:
an input shaft for receiving an engine torque;
an output shaft for outputting a changed torque;
a first planetary gear set having a first, a second, and a third rotational element;
a second planetary gear set having a fourth, a fifth, and a sixth rotational element;
a third planetary gear set having a seventh, an eighth, and a ninth rotational element; and
a fourth planetary gear set having a tenth, an eleventh, and a twelfth rotational element,
wherein the input shaft is connected to the fifth rotational element,
the output shaft is connected, to the eleventh rotational element,
the first rotational element is connected with the fifth rotational element and selectively connected with the seventh rotational element,
the third rotational element is connected with the eighth rotational element,
the sixth rotational element is connected with the tenth rotational element and selectively connected with the second rotational element,
the seventh rotational element is selectively connected to the fourth rotational element and the fifth rotational element, respectively, and
the ninth rotational element is connected to the twelfth rotational element and selectively connected to the second rotational element.

7. The planetary gear train of claim 6, wherein the fourth rotational element, the eighth rotational element and the ninth rotational element are each selectively connected with a transmission housing.

8. The planetary gear train of claim 6, wherein:
the first, second, and third rotational elements of the first planetary gear set are respectively a first sun gear, a first planet carrier, and a first ring gear of the first planetary gear set;
the fourth, fifth, and sixth rotational elements of the second planetary gear set are respectively a second sun gear, a second planet carrier, and a second ring gear of the second planetary gear set;
the seventh, eighth, and ninth rotational elements of the third planetary gear set are respectively a third sun gear, a third planet carrier, and a third ring gear of the third planetary gear set; and
the tenth, eleventh, and twelfth rotational elements of the fourth planetary gear set are respectively a fourth sun gear, a fourth planet carrier, and a fourth ring gear of the fourth planetary gear set.

9. The planetary gear train of claim 6, wherein:
the first, second, third, and fourth planetary gear sets are arranged in a sequence of the third, second, first, and fourth planetary gear sets from an engine side.

10. The planetary gear train of claim 7, further comprising:
a first clutch selectively connecting the fifth rotational element and the seventh rotational element;
a second clutch selectively connecting the second rotational element and the sixth rotational element;
a third clutch selectively connecting the second rotational element and the ninth rotational element;
a fourth clutch selectively connecting the fourth rotational element and the seventh rotational element;
a first brake selectively connecting the eighth rotational element and the transmission housing;
a second brake selectively connecting the ninth rotational element and the transmission housing; and
a third brake selectively connecting the fourth rotational element and the transmission housing.
